(19) United States
(12) Patent Application Publication
(10) Pub. No.: US 2013/0205610 A1
(43) Pub. Date: Aug. 15, 2013

(54) METHOD AND DEVICE FOR DETERMINING A LIFT HEIGHT OF A WORK MACHINE

(71) Applicant: Oliver Wildner, Hardthausen (DE)

(72) Inventor: Oliver Wildner, Hardthausen (DE)

(21) Appl. No.: 13/816,814

(22) PCT Filed: Jul. 29, 2011
(86) PCT No.: PCT/EP11/63112

§ 371 Date: Apr. 22, 2013

(30) Foreign Application Priority Data
Aug. 18, 2010 (DE) 10 2010 039 477.7

(51) Int. Cl. B66F 9/075; G01B 21/02

(52) U.S. Cl. CPC B66F 9/0755; G01B 21/02
USPC 33/701; 33/700

(57) ABSTRACT

In a method for determining a lift height of a work machine, a height measurement is carried out between a position along an approximately vertical movement axis of a lift element of the work machine to a reference point. In order to output a correct lift height constantly despite tire wear occurring on the wheel of the work machine, the reference point is formed by the floor.

### BACKGROUND OF THE INVENTION

1. Field of the Invention

The present invention relates to a method for determining a lift height of a work machine, in which a height measurement is carried out between a position along an approximately vertical movement axis of a lift element of the work machine to a reference point, as well as a device for carrying out the method.

2. Description of the Related Art

In the case of work machines, such as, e.g., high-rack storage loaders, the operator selects the desired lift height of the lift element of the work machine by pressing a button, causing the lift element to assume the desired lift height automatically. To that end, it is necessary for the heights of the individual high-rack sections to be previously entered into the controller of the work machine.

Height measuring systems are situated on the work machine which measure the lift height between the lift element and a reference point, the reference point normally being a fixed point on the housing of the work machine. The distance of the fixed point to the floor is added as a fixed value to the measured lift height from the reference point to the lift element.

Since the distance of the reference point to the floor is considered to be a fixed value, tire wear may cause the lift height to be incorrect at the position of the lifting, and the lift element does not assume the necessary lift height to reach a particular section of the high-rack storage area. The operator then has to readjust the lift height manually, which is very time consuming.

### BRIEF SUMMARY OF THE INVENTION

The object of the present invention is thus to provide a method and a device for determining a lift height which always outputs the correct lift height despite tire wear or tire pressure change.

According to the present invention, the object is achieved in that the reference point is formed by the floor. This has the advantage that tire wear or changes in the tire pressure are taken into account when the lift height is set and the lift height is thus always output correctly. If an automatic lift height is set, the lift element is always moved to the necessary lift height.

In one embodiment, the lift height is determined by two partial height measurements measuring against one another, a first partial lift height being determined from a first fixed point on the work machine to the lift element, and a second partial lift height being determined from a second fixed point on the work machine to the floor. Dividing the measurement of the lift heights simplifies the evaluation. The ascertainment of the second partial lift height, which serves as the reference measurement with respect to tire wear, may take place at greater time lags than the ascertainment of the first partial lift height.

In one variant, a difference is formed between two second partial lift heights determined at different points in time. Since the second partial lift height measurement measures directly from the floor up to the second fixed point, the influence of tire wear of the work machine on the lift height is detected correctly.

In another specific embodiment, the first fixed point and the second fixed point are situated at approximately the same height on the work machine, the first and the second partial lift height being added to the lift height. Due to the agreement in the position of the two fixed points, no corrections are necessary in the determination of the lift height, apart from the addition of the explained difference.

The first fixed point and the second fixed point are advantageously situated at different heights on the work machine, the vertical distance between the first and the second fixed point to the first and the second lift height being added to it or subtracted from it for determining the lift height of the lift element above the floor. The reference measurement of the second lift height measuring system from the second fixed point to the floor ensures that local signs of tire wear, which may either be very slow or also very fast due to damage to the tire, does not falsify the measurement of the lift height. This corrective measure ensures that the lift height is always determined correctly.

One refinement of the present invention relates to a device for determining a lift height of a work machine, in which a height measurement is carried out between an approximately vertical position of the lift element of the work machine to a reference point. In order to be able to always provide a correct lift height despite the occurrence of tire wear of the work machine, the reference point is formed by the floor on which the work machine is located. Thus, at every position of the lifting, the correct lift height is output without the operator having to manually readjust. The lift element of the work machine therefore automatically reaches the appropriate level of the high-rack storage area at all times.

The lift height is advantageously determined by two partial height measuring systems measuring against one another, a first partial height measuring system determining a first partial lift height from a first fixed point on the work machine to the lift element, and the second partial height measuring system ascertaining a second partial lift height from a second fixed point on the work machine to the floor. This subdivision into two partial lift heights makes it possible for the two partial height measuring systems to be situated on a position of the work machine where direct access to the power supply and communication devices of the work machine are present.

In one variant, the two partial height measuring systems each include a sensor for wirelessly determining the first and the second partial lift height. This allows the partial lift heights to be ascertained in a manner which is advantageous in particular, since the sensors include evaluation electronics, for which reason no additional parts are necessary for the height measurement, which reduces the costs for the lift height measurement.

In one refinement, at least one sensor is designed as a laser sensor or an ultrasonic sensor. A laser or ultrasonic sensor is a height measuring system which may be acquired commercially, for which reason no research and development costs are incurred for the use of such a height measuring system.

The present invention allows numerous specific embodiments. One of them will be elucidated in greater detail with reference to the figures in the drawings.

### BRIEF DESCRIPTION OF THE DRAWINGS

FIG. 1 shows a schematic diagram of the lift height measurement on a work machine.

FIG. 2 shows an example for ascertaining tire wear on the work machine.

### DETAILED DESCRIPTION OF THE INVENTION

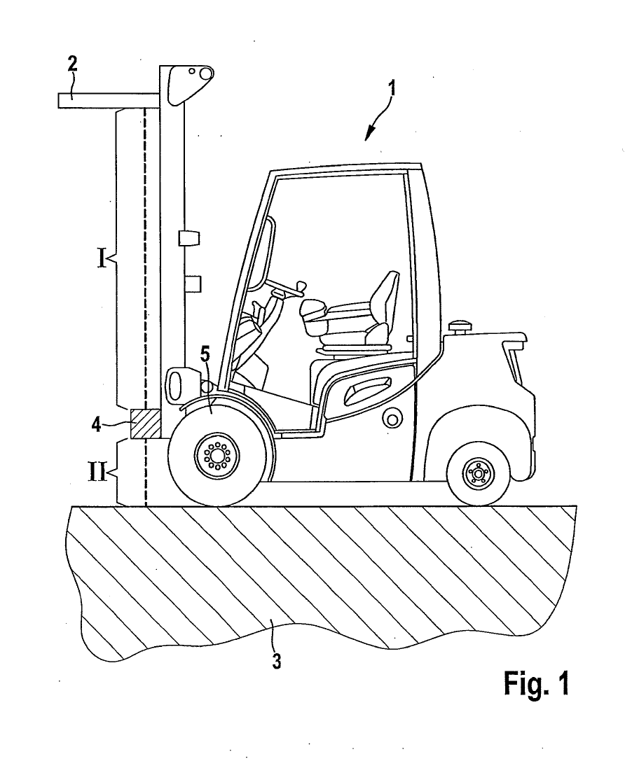

A schematic diagram for the lift height measurement on a work machine is shown in FIG. 1. In this case, the example of a forklift truck is considered, which must assume different lift heights in order to load a high-rack storage area having multiple levels. Work machine 1 in this case has a lift element 2, which is adjustable perpendicularly to the direction of movement of work machine 1. Work machine 1 is situated movably on floor 3. A height measuring system 4 is situated on the bumper of work machine 1, it being made up of two partial height measuring systems. The two partial height measuring systems 4 are situated side by side at the same height on work machine 1, which is why only one partial height measuring system 4 is apparent in FIG. 1.

First partial height measuring system 4 measures starting from the position on the bumper of work machine 1 to lift element 2, while the second partial height measuring system measures starting from the point on the bumper of the work machine perpendicular to floor 3. The positioning of two different partial height measuring systems on the bumper of work machine 1 has the advantage that the power supply of the partial height measuring systems, and the communication of the partial height measuring systems may be connected directly from work machine 1 to partial height measuring systems 4 without major complications.

Each partial height measuring system 4 forms a sensor including an evaluation electronic system such as, for example, a laser sensor or an ultrasonic sensor, which emits a measuring beam. The first partial height measuring system transmits a measuring beam against lift element 2 which reflects this measuring beam. The second partial height measuring system transmits the measuring beam against floor surface 3, where it is also reflected. Each reflected beam is received again by first and second partial height measuring system 4 and evaluated. Both partial height measuring systems 4 work according to the same principle by determining the time between the transmission of the measuring beam and the reception of the reflected beam. From this, first partial height measuring system 4 ascertains a first partial lift height I, while second partial height measuring system 4 determines a second partial lift height II.

In order to adequately take into account the tire wear on the wheels of work machine 1, the floor on which the work machine moves is selected as the reference point for the measurement. In the selection of the floor as the reference point, each change of tire 5 of work machine 1 as a result of wear or the change in the tire pressure is immediately incorporated into the measurement of the lift height.

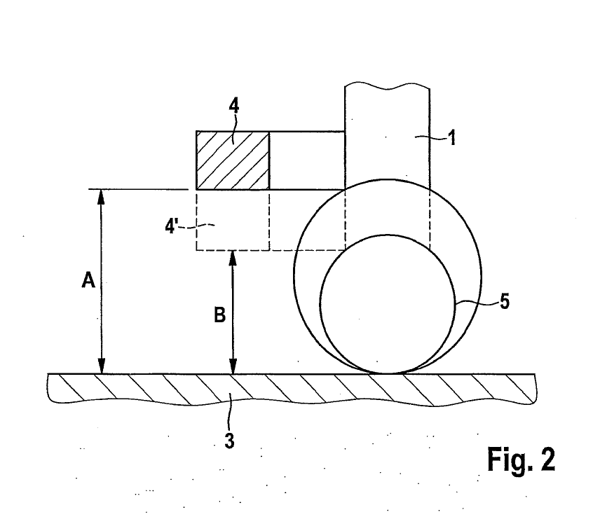

If, however, the fixed point of the first partial height measuring system on the bumper of work machine 1 is selected as the reference point for measuring the lift height, second partial height measuring system 4 carries out a reference measurement in order to detect changes in the tire. In this connection, second partial height measuring system 4 carries out two measurements A and B, as they are shown in FIG. 2 for second partial height measuring system 4. At a first point in time, second partial height measuring system 4 measures a second partial lift height II from the second fixed point on work machine 1 to floor 3. This first measurement A is used to determine a diameter of tire 5 of work machine 1. After a lapsed period of time which may be in the order of days, a second measurement B is carried out, the diameter of tire 5 of work machine 1 also being determined again. Subsequently, measurement B is subtracted from measurement A. If difference A is then not equal to zero, i.e., there is a positive difference A, it may be assumed that tire 5 is worn out, since the diameter of tire 5 has decreased. In this connection, the distance of second partial height measuring system 4′ (which is shown in dashed lines in FIG. 2) to floor 3 has also decreased. In order to be able to re-set the correct lift height automatically, in subsequent measurements, this difference A is added to first partial lift height I, which is measured by the first partial height measuring system between the point of attachment of the first partial height measuring system on work machine 1 and lift element 2, and to second partial lift height II, which is ascertained by the second partial height measuring system. The sum of partial lift heights I and II plus difference A from measurement A and measurement B of the second partial height measuring system, then results in the correct lift height. This ensures that the wear on the tires of wheels 5 of work machine 1 does not falsify the setting of the lift height.

The continuous determination of the second partial lift height ensures that when the operator chooses a lift height by pressing a button, the lift height is always automatically set consistently with the local conditions without the necessity of a manual readjustment by the operator.

The present invention may advantageously be used not only in conventional forklifts, but also in the loading of high-rack storage areas or lifting platforms.

1-9. (canceled)

10. A method for determining a lift height of a work machine, comprising:
performing a height measurement between a position along an approximately vertical movement axis of a lift element of the work machine to a reference point formed by the floor.

11. The method as recited in claim 10, wherein the height measurement for determining lift height includes two partial height measurements, a first partial lift height being determined from a first fixed point on the work machine to the lift element, and a second partial lift height being determined from a second fixed point on the work machine to the floor.

12. The method as recited in claim 11, wherein two separate measurements are made at different points in time for the second partial lift height, and a difference is formed between the two second partial lift height measurements made at different points in time.

13. The method as recited in claim 11, wherein the first fixed point on the work machine and the second fixed point are situated at approximately the same height on the work machine, and wherein the first and second partial lift heights are added to determine the lift height.

14. The method as recited in claim 11, wherein the first fixed point and the second fixed point are situated at different heights on the work machine, and wherein the vertical distance between the first and second fixed points is one of added to or subtracted from the sum of the first and second partial lift heights to determine the lift height of the lift element above the floor.

15. A device for determining a lift height of a work machine, comprising:
a measuring system for measuring a height between a position along an approximately vertical movement axis of a lift element of the work machine to a reference point formed by the floor.

16. The device as recited in claim 15, wherein the measuring system includes two partial height measuring systems, a first partial height measuring system measuring a first partial lift height from a first fixed point on the work machine to the lift element, and a second partial height measuring system measuring a second partial lift height from a second fixed point on the work machine to the floor.

17. The device as recited in claim 16, wherein the two partial height measuring systems each include a sensor for wirelessly determining the first and second partial lift heights.

18. The device as recited in claim 17, wherein at least one sensor of the two partial height measuring systems is one of a laser sensor or an ultrasonic sensor.
